(19) United States
(12) Patent Application Publication
(10) Pub. No.: US 2024/0062245 A1
(43) Pub. Date: Feb. 22, 2024

(54) CHARGING FOR ELECTRIC VEHICLES

(71) Applicant: Scott Rohrbaugh, Bellevue, WA (US)

(72) Inventor: Scott Rohrbaugh, Bellevue, WA (US)

(21) Appl. No.: 18/452,329

(22) Filed: Aug. 18, 2023

Related U.S. Application Data
(60) Provisional application No. 63/371,852, filed on Aug. 18, 2022.

(51) Int. Cl. G06Q 30/0251; B60L 53/57; G06Q 20/10; G06Q 30/0238

(52) U.S. Cl. CPC G06Q 30/0266; B60L 53/57; G06Q 20/10; G06Q 30/0238

(57) ABSTRACT

An example mobile platform can be equipped with an electrical energy source and one or more of: static or dynamic billboard content displayed externally on sides or rear of the mobile platform using light-emitting displays; externally-facing sensors affixed to the mobile platform, including one or more of: cameras; radar; Lidar; and atmospheric sensors; onboard computers to provide source content for the dynamic billboard content on the mobile platform, and to store data collected from the externally-facing sensors on the mobile platform; and communications equipment to send and receive data related to advertising content, onboard sensors, and control thereof.

### RELATED APPLICATIONS

This patent application claims the benefit of U.S. Patent Application No. 63/371,852 filed on Aug. 18, 2022, the entirety of which is hereby incorporated by reference.

### BACKGROUND

Current projections by the Federal Government and automobile manufacturers and trade groups suggest that US roads will support 25 million Electric Vehicles (EVs) by the year 2030. These vehicles will need to be charged—and if current yearly vehicle mileage totals and efficiencies hold, their energy demand will exceed 90 billion kWh. It is expected that 85% of this demand will be met by At-Home (AH) charging, but the remaining 15%—approximately 13.5 billion kWh—will need to be provided by Away-From-Home (AFH) charging.

The current standard for AFH charging is the public charging station. Public charging stations are installed in locations that are notionally frequented by drivers of EVs, and they provide energy at rates ranging from below 10 kW to 350 kW, delivered via Alternating Current (AC) or Direct Current (DC).

While they theoretically meet the AFH charging needs of many customers, public charging stations also exhibit an array of characteristics that can limit their real usefulness: they can be located in areas with limited practical access; they can exhibit erratic performance; they can be difficult to use; they are frequently broken. In practice, a significant fraction of the AFH chargers ostensibly available for use in a given geography at a given time are not usable. For charging station owners and operators, AFH charging is expensive to install and maintain, and its payback period is long.

For these reasons, public charging networks often fail to meet the needs of many current and potential EV drivers—and they are likely to continue to fail to meet those needs into the future, as EV adoption accelerates.

AFH charging is ironically grounded on the foundation of AH charging. As previously stated, the majority of the US EV fleet's yearly energy consumption will be delivered at home, and the potential for AH charging is often framed as a positive attribute of EV ownership, implicitly emphasizing the convenience, low cost, and control that AH charging brings. But for those drivers who do not have persistent, ready, and reliable access to AH charging, such as people who live in apartment buildings or who park on the street, AH charging is largely irrelevant—and its absence can preclude EV ownership, thus obviating the need for any form of AFH charging.

Even when it works as promised, the time cost of charging an EV is significant: fully recharging an EV's battery can take several hours, depending on charge rates supported by the charger and by the vehicle. (For example: a 6.67 kW charger will require 9 hours to fully charge a 60 kWh battery.) Typical AFH charging practice is to use a high-rate charger to deposit a minimum amount of energy in the vehicle, but even a charge energy as small as 15 kWh can take 45 minutes when charging at 20 kW. (AFH charging stations exhibiting higher charging rates exist, but they are less common than lower rates—and many EVs cannot accept high charging rates, regardless of charger performance.)

A non-negligible time cost for EV charging places even greater importance upon the location where charging takes place: the longer a user needs to be in the vicinity of a charger, the more important it is for them to be able to make use of that time. A common solution to that problem is to offer attractive features near charging stations; a converse solution is to enable charging to be conducted at locations where users already want to be.

Many EV drivers, much like drivers of non-EVs, spend the bulk of the time in which they are away from home at a workplace. Consequently, many workers—and the companies they work for—desire some level of EV charging at those workplaces. Indeed, many workplaces do offer some degree of EV charging. But inspection reveals that most workplace charging is often de minimis, offering the barest amount of charging capacity, as measured by the number of chargers installed and/or their performance.

The presence of only minimal amounts of charging at a workplace can be excused—charging equipment is expensive and exhibits long lead times, and it may be unclear who, in a tenant/landlord relationship, should pay for the direct costs of charging equipment installation. Furthermore, performance limitations in the electrical utilities that supply workplaces with power may constrain the additional power that can be delivered to charging systems there.

### SUMMARY

In one aspect, an example mobile platform can be equipped with an electrical energy source and one or more of: static or dynamic billboard content displayed externally on the front, sides, rear, and/or roof of the mobile platform using light-emitting displays such as Liquid Crystal Displays (LCD) and/or Light Emitting Diode (LED) screens; externally-facing sensors affixed to the mobile platform, including one or more of: cameras operating in one or more spectral ranges; LIDAR; RADAR; ultrasonic sensors; magnetic field sensors; air quality or gas sensors; onboard computers to provide source content for the dynamic billboard content on the mobile platform, and to store data collected from the externally-facing sensors on the mobile platform; onboard position-determining equipment such as GPS, Wi-Fi, and/or inertial navigation sensors, and communications equipment to send and receive data related to onboard sensors, vehicle position, advertising content, and control thereof.

### DESCRIPTION OF THE DRAWINGS

FIG. 1 shows an example high-level sequence of events in charge delivery servicing consumer vehicle.

FIG. 2 shows example use of a Charge Delivery Vehicle (CDV) as a deployment platform for additional applications.

FIG. 3 shows example applications and information flow on a CDV.

FIG. 4 shows example applications and information flow between a CDV and a remote computer.

FIG. 5 shows an example high-level sequence of events in peer charge delivery to a consumer vehicle.

FIG. 6 shows example supply-side and demand-side participants of the initial, and the peer-to-peer, energy brokerage system.

FIG. 7 shows an example model nomenclature.

FIG. 8 shows example use of peer vehicles as a deployment platform for additional applications.

FIG. 9 shows an example demand-side graphical user interface model.

FIG. 10 shows an example supply-side graphical user interface model (non-peer charge delivery).

FIG. 11 shows an example supply-side graphical user interface model (peer charge delivery).

### DETAILED DESCRIPTION

This disclosure relates to the delivery of charge to electronic vehicles as a service. This can include one or more of a delivery vehicle, batteries, sensors, and other media (such as advertisements).

A potential solution to the problems raised above is to switch the paradigm for EV charging from one where vehicles are brought to a suitable charging system/facility (the “gas station” paradigm”) to one where energy and charging equipment is brought to the vehicle in need of charging. In such a scheme, a range of complications associated with installed charging systems can be reduced or circumvented altogether: the cost and lead-time of integrating charging into a building or site can be eliminated; grid electrical supply constraints can be avoided; system uptime can be maximized by maintaining equipment in a depot instead of in the field; charging can be deployed and redeployed to locations where customers perceive it to be of greater usefulness; charging can be made available in locations where it otherwise would be absent, potentially including roadsides where stranded vehicles may find themselves in the case of an emergency.

To bring charging to customers' vehicles, both an energy source and corresponding charging equipment must be made mobile, by mounting it on a moving vehicle (either the bed of a truck/van, or on a trailer) as part of a combined charge-delivery system. The system must be deployable as a service to customers or customer-accessible locations on-demand or scheduled/arranged in advance. Customers must be able to discover the charge-delivery service and locate the system, and system operators must be able to make a physical connection between the system and the customer vehicle. System operators must be able to receive funds from customers. If these criteria can be met, a charge-delivery service may be of value to a wide range of current EV operators and open up EV ownership to a range of customers who are currently excluded by practical concerns.

It is one thing to offer a theoretical solution to a customer problem; it is another to build a sustainable business around that solution. In order to offer high quality of service to customers while simultaneously offering enough financial incentive to the operators of a charge-delivery service, we propose the reframing of the system as a platform, wherein the primary charge-delivery service is supported in conjunction with, or independently of, applications that can generate value for additional customer sets, and corresponding revenue for the charge-delivery service operator.

Additional applications may take many forms. One form may be mobile billboard advertising, where the vehicle operates displays mounted on its exterior while transiting from location to location, or while charging. Another form may be data collection and exploitation, including the use of license-plate recognition systems mounted on the exterior to collect the identities of vehicles on the road or in the parking lot near the charge-delivery system. Data collection could also include infrastructure scanning, or atmospheric data collection. Yet another form could be the use of the charge delivery vehicle as a conveyor of passengers, parcels, or food. Many other possibilities exist. In each of these cases, the use of the charge-delivery system's vehicle as a platform for other purposes allows additional revenue streams to be accessed using a common cost structure (the vehicle and the system operator).

We analogize the concept proposed here to the present position in the evolution of high-performance workplace computing: where high-performance workplace computing once took the form of a large mainframe installed in an office, co-located with the employees that it served, that compute capability is now chiefly found in the form of cloud computing, with that capability sold to workplaces as a service. Cloud computing frees workplaces from having to perform installation, maintenance, upgrades, etc. and instead allows them to simply use that compute. The cloud computing operator is free to use for their own purposes the compute capability that is not allocated to a primary customer. Commonly, “their own purposes” translates to other revenue-generating activities.

Offering charging to workplaces, residences, commercial properties, etc. as a mobile system unlocks similar benefits to the EV charging consumer, freeing them from all the burdens of charging save paying for it. At the same time, use of the system as a platform allows the system operator to focus on quality of service and access new and original revenue streams.

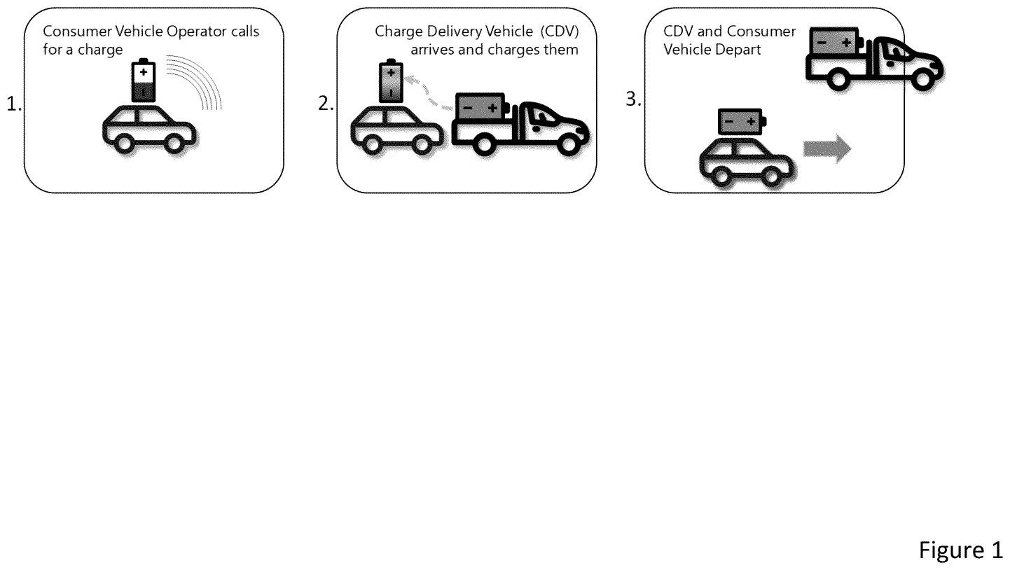

In view of this, a potential solution for drivers with poor access to at-home charging and for workplaces who seek to offer it without commitment or complication, and a potential alternative to public charging stations, is charging-as-a-service: the delivery of electrical energy to customers who need it, where they are, and when they need it. Examples of this technology are provided in FIGS. 1-11.

More specifically, by marrying an electrical energy source (most practically, this energy source is a large battery, but other sources like flywheels or generators will do) and charge-export circuitry to a vehicle that can support and transport it, energy can be delivered to customers upon request: customers who have limited access to overnight charging; Electric Vehicle (EV) drivers in areas with few extant charging stations; EV drivers with stranded vehicles; commercial EVs on a constrained route or on a jobsite; and more. Such a vehicle could be dispatched upon consumer need, scheduled in advance for charge delivery, or deployed to simply “loiter” in areas of high forecasted demand.

FIG. 1 displays the high-level sequence of events for the delivery of charge to a consumer vehicle. In this example, a consumer vehicle operator requests a charge for his or her EV. Once the request is received, a Charge Delivery Vehicle (CDV) is deployed to the location of the EV and provides a charge for the EV. Once the desired charging is completed, the CDV drives to another EV or returns to a central hub.

Regardless of how a driven charge-carrying truck like the CDV is deployed, it requires a driver, and that driver must be paid for. The cost of a driver's labor, however, can attenuate or eliminate the economic argument of driving a vehicle and selling charge to customers. A potential solution to this problem is to introduce independent modes that can generated revenue while the vehicle is being operated for its primary purpose of delivering charge to customers. There is no principled constraint on the array of possible independent modes that can be operated from the charge delivery platform, though concrete examples include the use of the vehicle as a mobile billboard or a mobile data collection platform.

Use of the CDV as a platform from which additional applications can be deployed is key to its economics: leveraging the fixed cost of the CDV and the driver to generate additional revenue relaxes the requirement that charging generate outsized sales and thus allows energy prices to be set favorably relative to competitive AFH charging services. Each additional application that can be deployed from the platform dilutes the cost of the platform, and in-turn allows the economics of that application to be driven by the variable cost of the application itself.

Described here is a concept for a transport vehicle like a CDV that can simultaneously do one or more of:
deliver electric charge to vehicles in need of it;
display billboard-like advertising during its operation; and/or
collect, analyze, transmit, and/or receive data from onboard sensors and remote data sources including vehicle position sensors; and/or
perform other functions en-route, or at the destination, using the CDV as the platform from which those other functions are deployed.

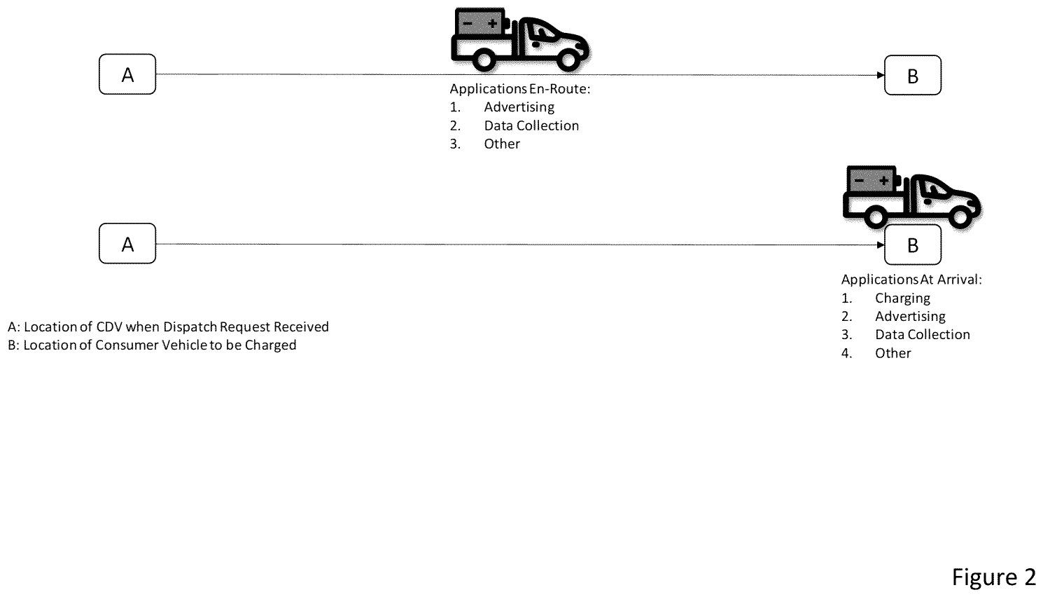

The use of the CDV as a platform for alternate applications is depicted in FIG. 2, which displays a Charge Delivery Vehicle (CDV) performing additional functions (beyond the primary function of delivering charge) while en-route to a customer EV (the recipient of the charge). While driving from A (the origination point) to B (the destination point), the CDV may display advertising on its outer surfaces (its front, sides, rear, and/or roof) using light-emitting displays such as Liquid Crystal Displays (LCD) and/or Light Emitting Diode (LED) screens; it may perform data collection from various sensors including one or more of: cameras in one or more spectral ranges; LIDAR; RADAR; ultrasonic sensors; magnetic field sensors; air quality or gas sensors; it may collect its location via GPS, Wi-Fi, and/or inertial navigation sensors; others. The CDV may also execute other applications such as the delivery of parcels, the in-field maintenance of charging customers' vehicles, and other non-information-based/non-energy-based tasks.

Additional applications may operate independently or in conjunction with each other. Examples of conjunctive operation are:
to display different advertising content in response to the transport vehicle's sensed location;
to display non-advertising visual content as directed by public agencies, such as emergency management or law enforcement groups.
to display different advertising content in response to the detection of the observed types of surrounding vehicles, or in response to the observation of specific license plates among nearby traffic; and/or
to sense road surface conditions and transmit data regarding those conditions to a remote server.

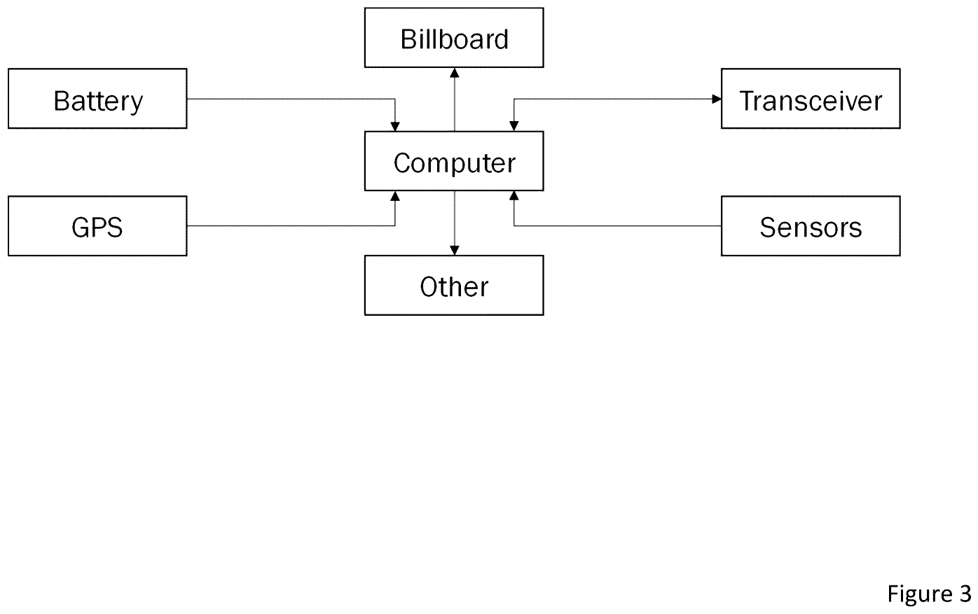

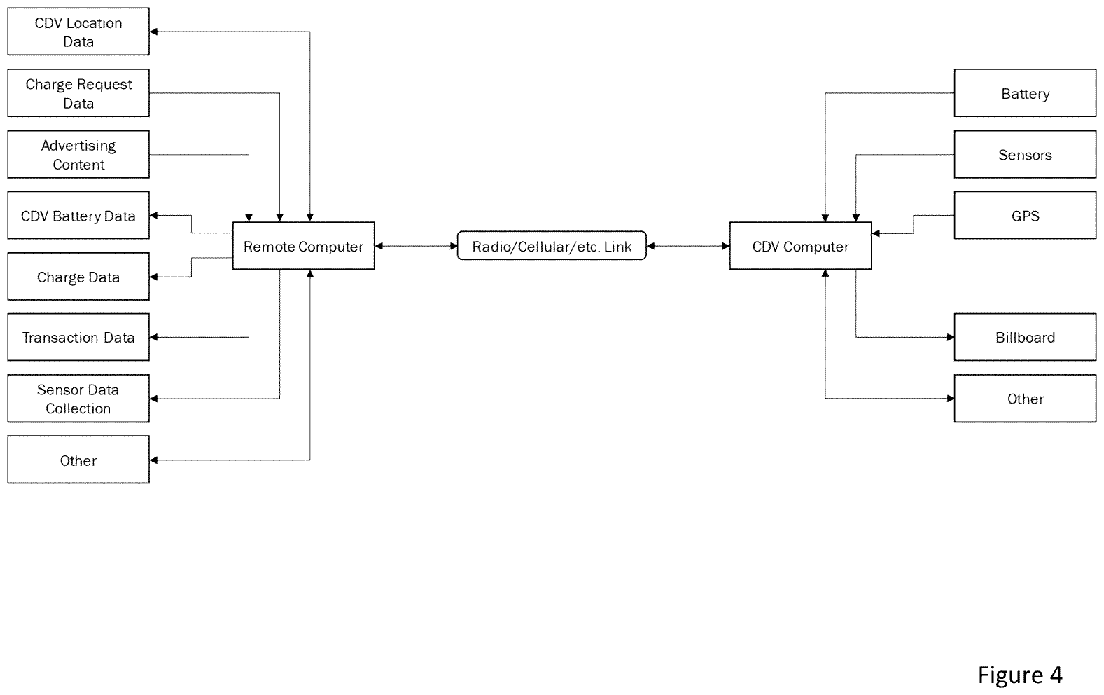

In such examples, the transport vehicle can have one or more computers that manage the function's operation. Each of the computers can include one or more processors and storage media. The storage media stores instructions which, when executed by the processor(s), causes the transport vehicle to provide the functionality described herein. A schematic view of such an arrangement is provided in FIG. 3, and the interaction of the computer and systems onboard the CDV with a controlling Remote Computer is depicted in FIG. 4.

FIG. 3 displays the high-level interconnectivity of a computer system installed onboard a Charge Delivery Vehicle (CDV) in order to support the functionality described in FIG. 2. With primary flow of information indicated by the figure's arrows, the computer sends and/or receives information from various peripheral systems to which it is connected. The computer receives information from the battery/batteries and its associated systems regarding its state of charge/state of health in order to estimate the system's capacity for charge delivery and the status of active charging jobs. The computer sends advertising content to the vehicle's billboard surface(s) and governs when and to what that content is to be updated. The computer communicates with a transceiver (Wi-Fi, radio, cellular, etc.) in order to receive dispatch and advertising instructions, and to send information regarding the operating condition of the onboard battery/batteries, the vehicle's position, to share data collected by onboard sensors. The computer aggregates, analyzes, and/or transmits data collected by any onboard sensors, including GPS and the other sensors described in FIG. 2. The computer may also communicate with various other devices on the vehicle, such as data storage devices, signaling devices, peripherals such as displays or remote terminals, and/or other electronic equipment attached to the onboard battery/batteries.

FIG. 4 displays the high-level interconnectivity between the Charge Delivery Vehicle's (CDV's) onboard computer and a remote computer, for the purposes of: managing the execution of charging dispatches and directing the CDV to specific customers; governing and updating advertising content; measuring the parameters of charge delivery to customers and collecting corresponding transaction data; for collecting raw and processed data from sensors onboard the CDV; for sending and receiving data associated with other applications not captured by the preceding, potentially including information related to non-information-based/non-energy-based applications. The remote computer will communicate with the computer onboard the CDV via radio/Wi-Fi/cellular/LoRaWAN connections.

The functions of the CDV can only be accomplished if a party can direct the vehicle outside of the vehicle to drive to a particular location, at a particular time, to perform one or more of the functions described above at the final destination and/or along the route to that destination.

The primary application of the CDV is to deliver charge, and as such, it will primarily be dispatched to a particular location at a particular time to deliver charge to a particular customer or set of customers. (Or it will “loiter,” as previously discussed, in a location where drivers can easily find it.) When both the CDV and customer vehicle have arrived at the charging location, the operator of the CDV will establish a physical connection between the vehicles and will initiate the transfer of charge between them. The onboard computer of the CDV will govern and measure the transfer of charge, validate its transfer to the consumer vehicle, complete the charge delivery process at the appropriate time, and will initiate the transfer of funds from the customer.

In the primary charging application, a separate customer-facing software application will be required for a customer to signal demand by requesting a charge, to arrange a charging location, and to transact for those services.

Non-charging applications will require their own “customer-facing” software, allowing customers of non-charging applications (notionally advertisers, consumers of data, and/or others) to solicit, receive, and transact for such services.

The same dispatch and charge/transaction-management processes that are required to support a dedicated CDV as previously discussed could also be useful in supporting low-power/low-energy charge delivery by consumer EVs. In such a scenario, consumer EVs (peers) capable of exporting charge to other consumer EVs would be dispatched to charge consumers using the same dispatch processes as for the dedicated CDV.

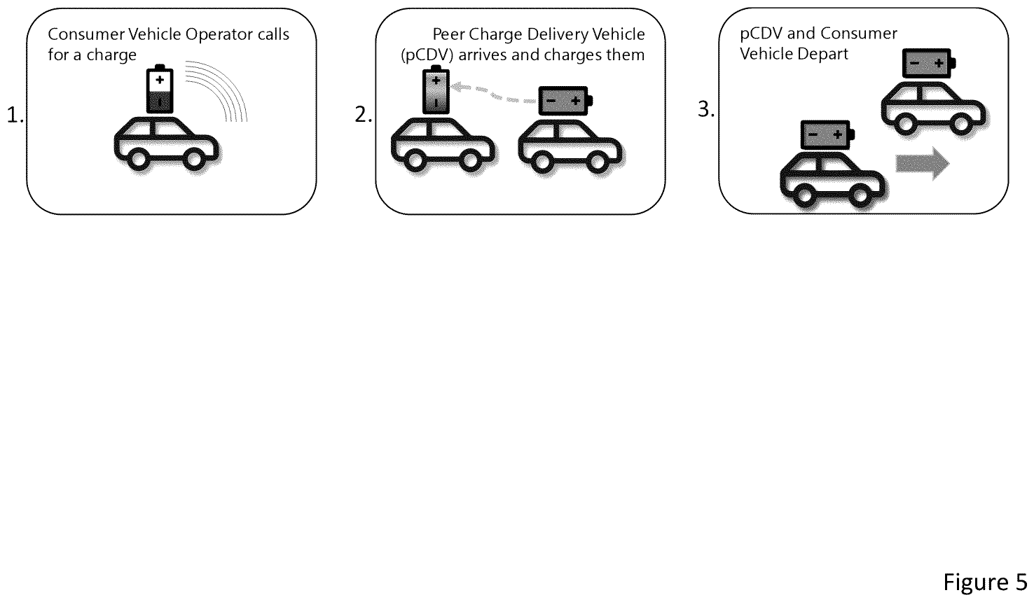

FIG. 5 depicts the process of a Peer CDV servicing a consumer EV in need of charge, which displays the high-level sequence of events for the delivery of charge to a consumer vehicle from a “peer” consumer vehicle. In this example, a consumer vehicle operator requests a charge for his or her EV. Once the request is received, a nearby consumer vehicle equipped with suitable energy export equipment (pCDV) is directed to the location of the customer EV and provides a charge for the EV. At charge completion, the supply-side participant measures the energy transferred to the demand-side participant, validates the transfer of charge to the customer, and initiates the transfer of funds from the customer. Once the desired charging is completed, the pCDV drives to another EV or continues along to another activity.

Furthermore, the processes that could broker, validate, and transact connections between a customer and source of peer charging could be used to broker connections between a customer and a stationary source of charging, such as extant charging hardware or even standard 120V/220V/480V AC outlets, made available at businesses, municipal facilities, and even homes. Such a scheme, notionally identified as E2V charging, could even broker connections between vehicles in need of charge and commercial, non-peer charging stations.

An extension of the brokerage process to a diversity of energy consumers is also possible. As society-wide electrification efforts progress, energy consumers who traditionally used energy in the form of fossil fuels will increasingly use it in an electrical form. (Electrified construction equipment, electric aircraft and their support equipment, electric watercraft, electrical energy sources for events, backup power, and emergencies are a non-comprehensive list.) These consumers may all encounter scenarios where their operation requires energy that they do not have, and which is not sufficiently obtainable from the electrical grid. (Electric Vertical-Takeoff and Landing (eVTOL) aircraft and electric watercraft in particular have a reasonable likelihood of requiring electrical power at a location other than their primary operating base, given the nature of their operations.)

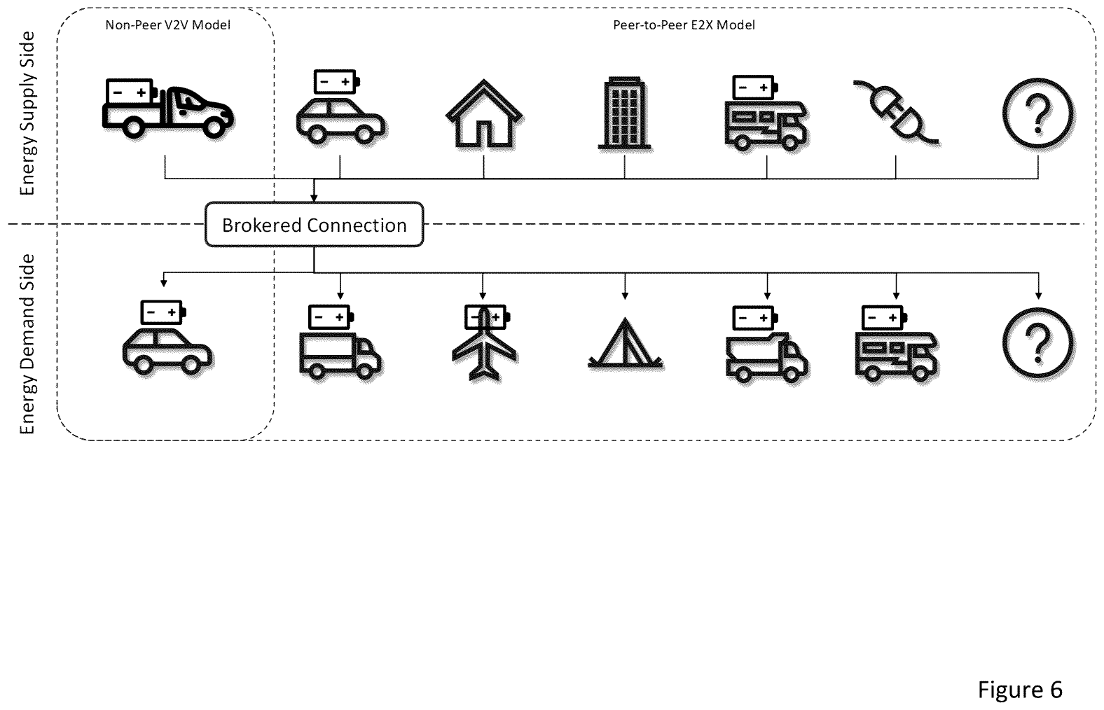

In such scenarios, the receipt of energy by a portable source may be key to their continued operation. Building on prior nomenclature, we call these charging scenarios E2X modes. The extension of the Vehicle to Vehicle (V2V) energy brokerage system to the E2V model and beyond to a diverse, but limited, array of potential energy consumers is shown in FIG. 6.

FIG. 6 displays the range of potential energy suppliers and energy demanders in the initial non-peer V2V energy brokerage model and the extended energy brokerage model including peer participants and a diverse array of potential energy consumers. In the former, the supply-side participant is envisioned to be a dedicated Charge-Delivery Vehicle (CDV), equipped to deliver recharging services and to support independent applications such as advertising, data collection, and others. In the former, the demand-side participant is envisioned to be a consumer EV. In the supply side of the latter model, participants include the dedicated CDV, but also include peer CDVs, structures with accessible charging stations or electrical outlets, recreational vehicles, traditional charging stations, and others. In the demand side of the latter model, participants include consumer EVs, industrial and municipal EVs, electric aircraft, outdoor events in need of grid-independent electricity, disaster sites, construction sites, recreational vehicles, and more.

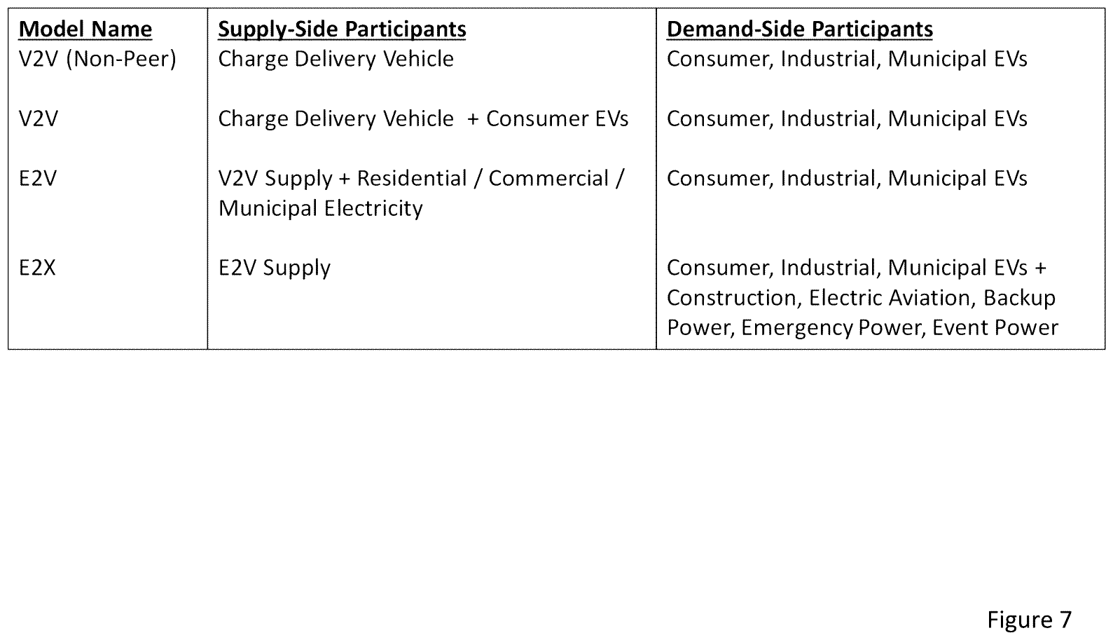

FIG. 7 articulates the different potential supply-side and demand-side participants for the listed modes. More specifically, FIG. 7 associates, for clarity, the name of various energy brokerage models and the supply-side and demand-side participants of each.

Building on the platform financial model that attached to the initial V2V mode, the supply-side participants of the E2X mode may find it attractive to operate additional revenue-generation applications in parallel to energy provision. Operators of consumer vehicles sharing their energy may wish to participate in the collection of publicly obtainable data; they may wish to present advertising on the sides of their vehicles. The methods used to support myriad applications on the CDV presented at the beginning of this document may also be used to support similar applications deployed on peer participants' vehicles and structures.

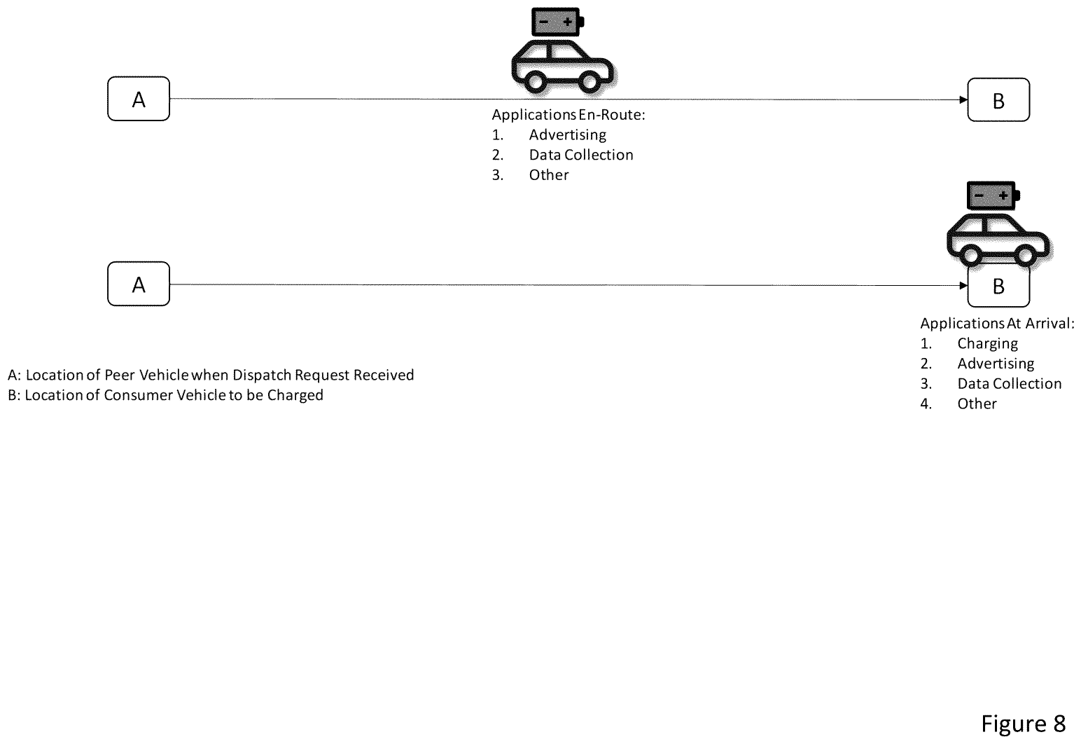

The extension of the platform model to peer CDVs is shown in FIG. 8, which displays a peer Charge Delivery Vehicle (pCDV) performing additional functions (beyond the primary function of delivering charge) while en-route to a customer EV (the recipient of the charge). As with the dedicated CDV, the pCDV may support additional functions while driving from A (the origination point) to B (the destination point). It may display advertising on its outer surfaces (its front, sides, rear, and/or roof); it may perform data collection from various sensors including: individual or multiple cameras in one or more spectral ranges; LIDAR; RADAR; ultrasonic sensors; magnetic field sensors; air quality or gas sensors; it may collect its location via GPS, Wi-Fi, and/or inertial navigation sensors; others. The pCDV may also execute other applications such as the delivery of passengers or parcels, the in-field maintenance of charging customers' vehicles, and other non-information-based/non-energy-based tasks.

Software supporting the E2X mode could also support the use of positive and negative incentives in its operation. Businesses offering the use of their electrical services may find it useful to offer discounts for their own primary offerings, or to validate charging costs, when charging customers patronize their facilities, or even to integrate charging fees into in-person transactions at the business' point-of-sale system. The E2X software could indicate the existence of such incentives to charging customers by displaying lower charging prices, indicating the existence of coupons/validations, or by in-software advertising. E2X software could also be used to filter supply types for co-location with food, shopping, or other facilities.

In the case of service abuse or mis-use by charging customers, supply-side participants of all types may find it useful to raise prices to, or levy fees upon, the registered user of the service. Charging customers may even be “banned” from procuring charging services from particular suppliers, in which case the supplier would be hidden from the charging service customer's view when using E2X software to find charging services.

By preserving records of transactions, the E2X software may enable incentives and disincentives such as supply-specific loyalty programs or damage-prevention fees and may allow customers the ability to download their usage data for use in energy-consumption-tracking applications or other.

Also described here is a software application-based method for operators of EVs in need of a charge to discover, exchange energy, and transact with operators of EVs or other sources capable of exporting electrical energy, and for other consumers of electrical energy to access the same energy brokerage framework. This will be referred to as a “E2X Energy Marketplace” and the software application itself as the “E2X app”.

Basic E2X App Version (V2V Mode):

The proposed workflow is as follows. A driver in need of energy (demand-side driver) would open the E2X app (if using a mobile device) or the website (if using a computer). As described above, such devices can include processors and memory encoding instructions thereon to allow for the execution of the functionality described herein.

The demand-side driver would enter the approximate number of miles needed, either as a numeric entry or as a pair of geographic locations (the origination and destination points). The demand-side driver would next enter the location where the charge is needed (defaulting to the starting location entered in the previous step, or the driver's current location if no location was entered in that step), along with the time when the charge is needed. Following entry of these criteria, the demand-side driver would submit the request, which would be passed by the E2X app or website to a backend computer for processing.

The demand-side driver would be prompted upon first use to create a profile on the E2X app, potentially including information like name, vehicle plate number, make/model/year/color or VIN, phone number and email. Because different vehicles have different ratios of miles driven per kWh used, and different maximum charge rates, the backend computer would use vehicle information to calculate a demanded kWh value from the mileage requested and an estimated time to complete the charge (potentially using local weather information such as temperature to modify delivered kWh and charge rates from nominal values).

Upon request submission, the backend computer would send the request to a set of supply-side drivers within range of the demand-side driver's charge location, where that range is defined by the time when the charge is needed, and the time required for each supply-side driver to get to that location. Information sent to the supply-side drivers would include the charge-delivery location, charge duration, and estimated fee.

After a predetermined, but ideally short, time, a list of accepting drivers would be shared with the demand-side driver to choose from. Information shared with the demand-side driver would include the estimated time to supply-driver arrival, estimated time to charge completion, and minimum fee. The demand-side driver would be given the option to choose between one of the offered drivers or to cancel the transaction.

Upon demand-side driver acceptance, the backend computer would send charge location information, vehicle types, and user information to both the demand-side and supply-side drivers. The backend computer would also notify the demand-side driver to ensure that their vehicle is accessible with an exposed charge port.

At the appropriate time, the demand-side driver would be given an indication by the supply-side E2X app to go to the demand-side driver's destination, along with vehicle plate number and make/model/year/color information so that the supply-side driver can easily find the vehicle.

Upon arrival, the supply-side driver would connect their vehicle to the demand-side driver's vehicle through a charge cable interface. The Supply-side driver would indicate to the supply-side driver when to activate energy transfer, setting a timer whose value would be determined by the result of a calculation involving the miles requested by the demand-side driver, the miles/kWh ratio of their vehicle, and the power output ability of the supply-side vehicle. A short time prior to the completion of the timer, both demand-side and supply-side drivers would be notified to return to their vehicles to validate energy transfer. Following validation, the app would transfer funds from the demand driver to the supply-side driver via previously indicated payment methods.

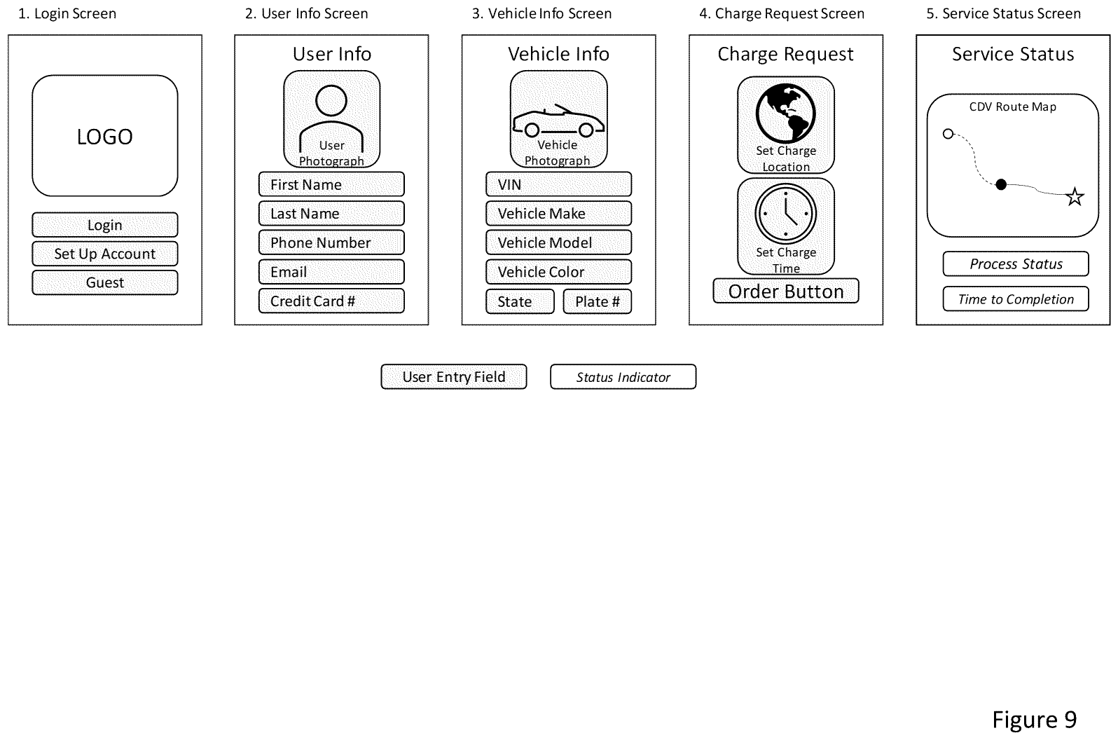

FIG. 9 displays a notional graphical user interface (GUI) for a demand-side participant in an E2X energy brokerage service. Screen 1 shows the potential arrangement of access modes, allowing users to log into an existing account, to set up a new account, or to proceed as a guest. The second screen displays a potential arrangement of user information, while the third screen shows a potential arrangement of vehicle information. Screen 4 displays a potential arrangement of charge request information, particularly where and when the charge is needed, but potentially to include a rough estimate of charge needed and other information. The final screen displays a potential configuration of service status information, including where the CDV is, in which phase of delivery the service is in, and the estimated time to completion. Information in these screens will be provided by the remote computer shown in FIG. 4. The demand-side participant GUI provides the primary signal of the existence and magnitude of demand for charging services by the brokerage network described here.

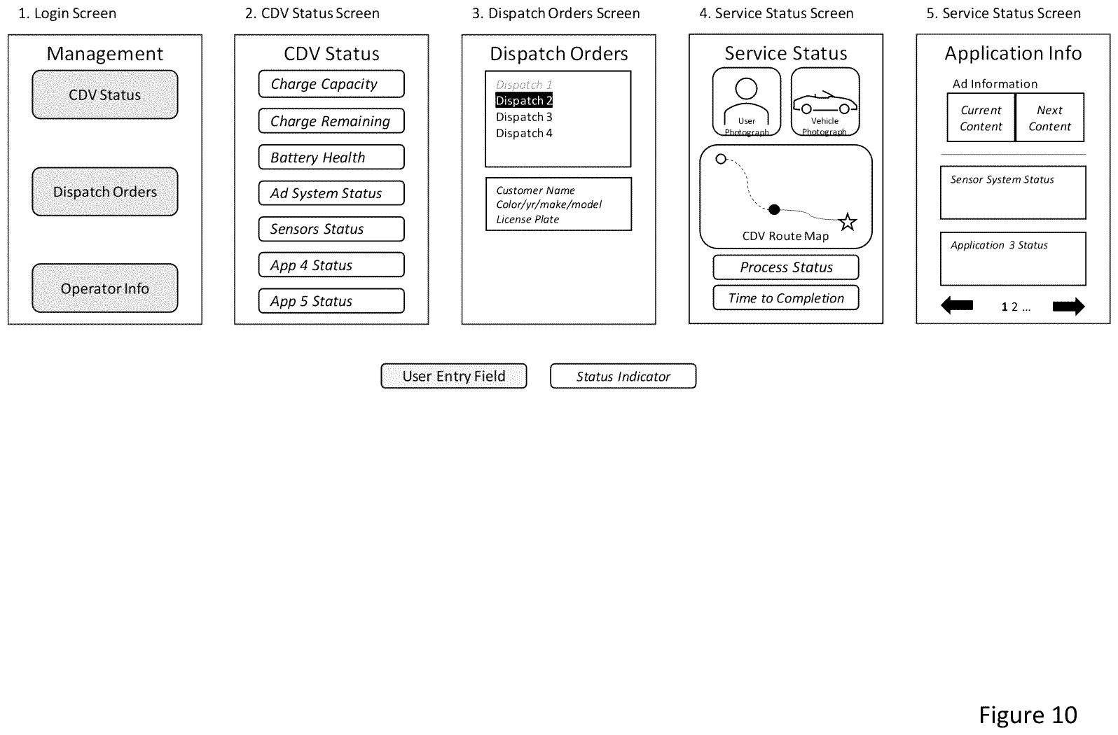

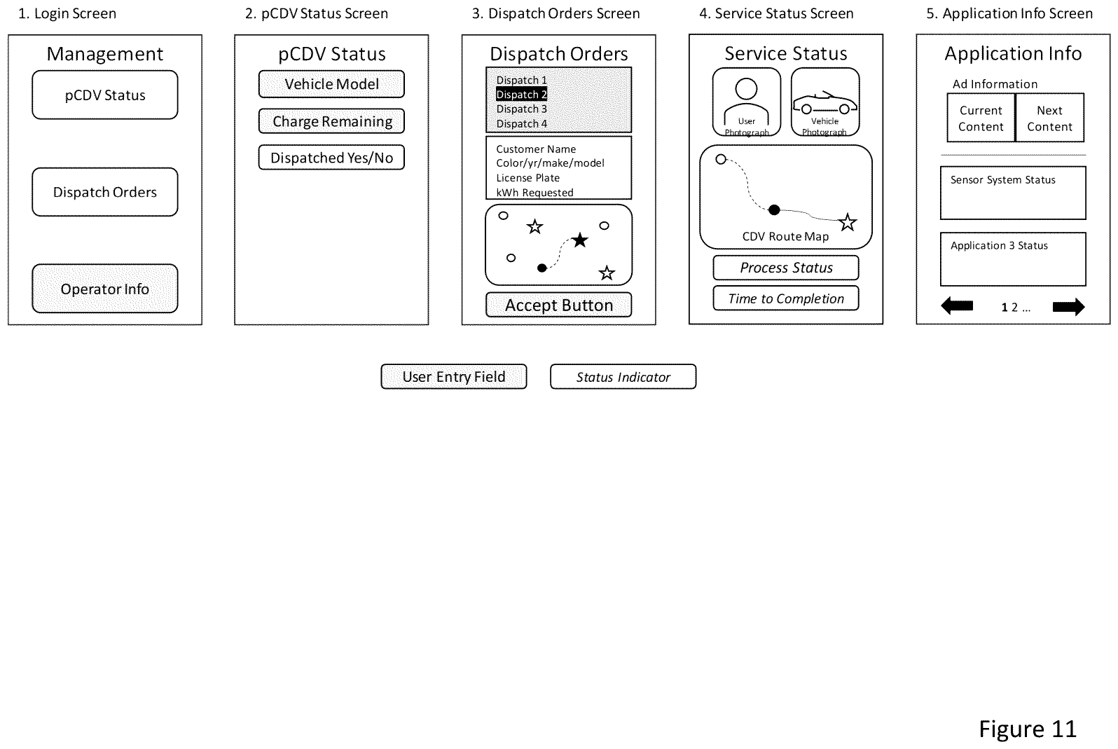

FIGS. 10 and 11 display notional GUIs used by the non-peer and peer-based Supply-Side CDVs.

FIG. 10 displays a notional user-facing Graphical User Interface (GUI) for a supply-side participant in an E2X energy-brokerage service. Screen 1 shows a potential arrangement of information sources regarding Charge Delivery Vehicle (CDV) equipment, dispatch orders, and the operator's information. Screen 2 shows information on the CDV's operating status, including the high-level status of various additional applications beyond the primary charge-delivery application. Screen 3 shows a potential arrangement of dispatch order information, including the sequence of dispatches and customer information corresponding to each dispatch. Screen 4 shows service status corresponding to each dispatch. Screen 5 shows a potential arrangement of detail screens corresponding to advertising content, onboard sensors, and other applications running on the CDV.

FIG. 11 shows a variant of the supply-side Graphical User Interface shown in FIG. 10, adapted for use by a peer Charge Delivery Vehicle (pCDV) participant. Chief differences between the CDV and pCDV variants can be seen on Screens 2 and 3. On screen 2, it is possible that the driver will have to manually enter their vehicle model and onboard battery status—it is expected that the peer EV will not exhibit a data connection between its onboard computer and a remote computer. Such, however, is possible. Screen 3 exhibits dispatch orders that the pCDV driver may optionally accept or reject, along with a map of other nearby drivers who could also potentially service the needs of the consumer. Otherwise, the screens remain identical; in both the CDV and pCDV versions, any number of non-energy applications may be supported by the vehicle in addition to the primary energy-delivery application.

An extension of this system involves the installation of energy transfer management applications on both the demand-side and supply-side vehicles, called a “vehicle-native app”.

In the vehicle-native app, both the demand-side vehicle and the supply-side vehicle have the app installed natively by the automobile Original Equipment Manufacturer (OEM), and the vehicle must exhibit some degree of connectivity.

In the vehicle-native app, all energy demand requests and supply responses are controlled through an interface on the respective vehicle's computer. Vehicle-nativity allows certain actions to be streamlined: energy requests can be made using the specific vehicle's mile/kWh ratio. The backend computer can direct suppliers to the exact location of the demanding vehicle, not just a location for which the user's cell phone is a proxy; the demand charging port cover can be unlocked digitally, without the manual intervention of the demand-side driver; the transfer of energy can be initiated and validated automatically by communication between each vehicle and the backend computer or directly between vehicles; the total energy transferred can be measured exactly by both the demand-side and supply-side vehicles; job completion and verification of such can be performed automatically or directly between vehicles.

Both the mobile app and the vehicle-to-vehicle app would keep logs of energy transfer to and from the vehicle, for recordkeeping use by both the vehicles' owners and interested third parties.

An intermediate embodiment of this system involves one driver (either demand-side or supply-side) using the vehicle-native app and the other using the mobile app. In this scenario, the validation and measurement of energy transfer, and verification of job completion could be performed by the vehicle-native app, regardless of which vehicle the native app is installed on.

Communication between the vehicle-native apps on both demand-side and supply-side vehicles can take place indirectly using a backend computer or set of computers as an intermediary, using cellular, radio, or Wi-Fi connectivity to link the vehicles and networks/computers. Alternately, communication between both demand-side and supply-side vehicles can take place directly, using cellular, Bluetooth, or Wi-Fi, or optically via the use of vehicle lighting as a transmitter and one or more onboard cameras as a receiver.

While the examples described here are centered on vehicle-to-vehicle energy transfer applications, the concept can be extended to non-vehicle sources as well. Traditional AFH charging stations hosted by businesses or municipal facilities can use the brokerage framework described here as an alternate customer discovery method, as can non-networked installed charging ports (ranging from DC Fast-Charging systems to low-power 110V AC plugs) hosted by businesses and potentially even by homes.

This conception of the E2X brokerage application would further expand access to charging for vehicular consumers in need of it.

The example software applications may also enable the sale of energy to non-ground vehicle consumers, such as off-the-grid events, construction sites with insufficient grid power access, industrial or commercial facilities during power outages, camping sites, and electric aviation vehicles. Examples of such transfers between different entities are depicted in FIG. 6.

What is claimed is:

1. A mobile platform equipped with an electrical energy source and one or more of:
static or dynamic billboard content displayed externally on sides or rear of the mobile platform using light-emitting displays;
externally-facing sensors affixed to the mobile platform, including one or more of:
cameras;
radar;
Lidar; and
atmospheric sensors;
onboard computers to provide source content for the dynamic billboard content on the mobile platform, and to store data collected from the externally-facing sensors on the mobile platform; and
communications equipment to send and receive data related to advertising content, onboard sensors, and control thereof.

2. The mobile platform of claim 1, wherein the onboard computers are programmed to dynamically control the dynamic billboard content in response to information collected by the externally-facing sensors or received by communications or position-determining equipment, including one or more of:
changing the dynamic billboard content based on location; or
changing the dynamic billboard content based on instructions received by the communications equipment.

3. The mobile platform of claim 1, wherein the electrical energy source is a battery.

4. The mobile platform of claim 1, further comprising position-determining equipment to determine a position of the mobile platform.

5. A peer-to-peer vehicle charging brokerage method, comprising:
signaling an existence of energy demand to a broader audience of potential suppliers;
directing approved suppliers of electrical energy to demanders;
validating a transfer of electrical energy between supplier and demander; and
enabling an exchange of funds between demander and supplier.

6. The method of claim 5, further comprising acting as a trusted third party to ensure that suppliers and demanders fulfill promises to each other regarding provision of service and the exchange of funds.

7. The method of claim 5, wherein an expanded set of suppliers includes:
consumer electric vehicles with an ability to export electrical energy;
municipal or industrial vehicles with an ability to export electrical energy;
traditional grid-backed fixed charging installations;
non-traditional grid-backed charging installations such as non-networked charging systems and 110V power outlets; and
fixed charging systems disconnected from a power grid;
wherein supplier participants in a brokerage network may be commercial organizations, noncommercial organizations, and/or individuals, wherein the brokerage network may be integrated with point-of-sale systems to enable discounts to be offered by nearby businesses to customers who use charging services affiliated with those businesses, or to enable unification of energy and non-energy transactions into a single bill.

8. The method of claim 5, wherein an expanded set of demanders includes:
consumer electric vehicles;
municipal or industrial vehicles;
recreational vehicles;
consumers of electricity in locations without sufficient electrical utility access;
electrical utilities experiencing high demand and in need of supplemental energy from non-utility-owned sources;
buildings and other grid-connected consumers of electricity who need more energy than can be reliably or cost-effectively provided by an electrical utility grid;
electrical aircraft including electric Vertical-Takeoff and Landing aircraft, on the ground at airports or away from airports;
electrical watercraft at or away from traditional moorage facilities;
wherein a brokerage application may allow for spontaneous and pre-scheduled charging and may maintain records of transactions.

9. The method of claim 8, wherein the brokerage application is further programmed to compare participants' performance in certain transactions against pre-arranged criteria describing those transactions to determine discounts, penalty fees, or other positive or negative feedback mechanisms governing future transactions on a network;
wherein the brokerage application is programmed to enable independent places of business to offer incentives to both energy demanders and suppliers who choose to perform recharging in their vicinity, and would enable location-correlated advertising; and
wherein the brokerage application is programmed to suggest meeting locations near to a location of the demander's requested recharge location in order to encourage recharging in locations that are safe, permissible by local regulations and private property-use rules, and to encourage sequential recharges by the same supplier to use the location, to minimize time to last-charge completion.
